(19) United States
(12) Patent Application Publication
(10) Pub. No.: US 2022/0334708 A1
(43) Pub. Date: Oct. 20, 2022

(54) Button with Changeable Size and Implementations in Surveys

(71) Applicant: Chian Chiu Li, Fremont, CA (US)

(72) Inventor: Chian Chiu Li, Fremont, CA (US)

(21) Appl. No.: 17/857,016

(22) Filed: Jul. 3, 2022

Related U.S. Application Data
(63) Continuation-in-part of application No. 16/831,663, filed on Mar. 26, 2020, now abandoned.

(51) Int. Cl. G06F 3/04845; G06F 3/0481; G06F 3/04886; G06F 3/04842; G06Q 30/02

(52) U.S. Cl. CPC G06F 3/04845; G06F 3/0481; G06F 3/04886; G06F 3/04842; G06Q 30/0203

(57) ABSTRACT

Systems and methods for presenting a button with a changeable size to attract a user's attention. In one aspect, a button is enlarged temporarily when an email, a short message, a tweet message is presented. In another aspect, a button is enlarged temporarily when a finger approaches the button. Implementations in surveys are illustrated.

### CROSS REFERENCE TO RELATED APPLICATION

This is a continuation-in-part of U.S. application Ser. No. 16/831,663, filed Mar. 26, 2020, which is a continuation-in-part of U.S. application Ser. No. 15/702,724, filed Sep. 12, 2017, which is a continuation-in-part of U.S. application Ser. No. 15/279,433, filed Sep. 29, 2016, which is a continuation-in-part of U.S. application Ser. No. 14/194,793, filed Mar. 2, 2014, now U.S. Pat. No. 9,483,774, granted Nov. 1, 2016.

### BACKGROUND—FIELD OF INVENTION

This invention relates to a user interface of an electronic device, more particularly to presentation of buttons in a user interface and implementations of buttons in surveys, emails, short messages, and tweets.

### BACKGROUND—DESCRIPTION OF PRIOR ART

After a user reads an email on an email page, the user often clicks a close button to return to an inbox page. The close button has only one function, that is, to close the email page and display the inbox page. There are often some other buttons or icons on the email page that also have a single function. Usually, a user clicks on one button to perform a function and then clicks on another button to go back to the inbox page. Having to click on two buttons takes extra time and may affect user experience.

Therefore, there exists a need for a dual-function button that performs a function and closes an email page.

Surveys on customer satisfaction are important for business. Surveys on social or political issues are important for the society and politics. Survey results benefit business owners, policy makers as well as the general public. For example for a business, surveys may be used to monitor customer service, improve product quality, detect defects, observe future trends, etc. Traditional surveys use a questionnaire that has many questions on several pages. The questions are often long and take time to comprehend. In addition, surveys often show up as an unwelcome surprise. Hence, no matter whether a questionnaire is on paper or on a screen, most people usually just shy away from it because, it is considered time consuming, burdensome, and intrusive. In many cases, even the allure of raffle prize won't make people answer survey questions.

Therefore, there exists a need for a survey which is quick, easy, and less intrusive.

Buttons presented in an interface have a regular size and fixed appearance. These buttons can be easily overlooked or ignored. It is desirable to configure certain buttons to make them stand out in some cases, such as buttons representing answers in a survey.

### Objects and Advantages

Accordingly, several main objects and advantages of the present invention are:
a). to provide improved systems and methods for a dual-function button and a button with a changeable size in a user interface;
b). to provide such a dual-function button for a survey email that answers a survey question and closes an email page;
c). to provide such a dual-function button for an email that submits an opinion and closes an email page;
d). to provide a button with a changeable size to attract the attention of a user;
e). to provide a button that has a larger size temporarily when a page is presented;
f). to provide a button that is enlarged temporarily when a finger approaches;
g). to provide improved systems and methods to generate or conduct a survey;
h). to provide such a survey which requires a single action only;
i). to provide such a survey which provides two options, a one-action survey and a multi-step survey; and
j). to provide such a survey in an email, a short message, or a tweet.

Further objects and advantages will become apparent from a consideration of the drawings and ensuing description.

### SUMMARY

In accordance with the present invention, a dual-function button is configured in an email. Upon activation, the button performs a function and closes an email page. A user may use the dual-function button to answer a survey question or submit an opinion quickly and conveniently. The dual-function button also may be configured in a short message or a tweet. To be more attractive, a button is enlarged temporarily when a finger approaches it. To be more attractive, a button on a page is enlarged temporarily when the page shows up. Further, a survey is designed which needs a single action only and is especially suitable for emails, short messages, and tweets. A survey may present a single question which is about user satisfaction and has one or a few words only. The survey process is quick, simple, convenient, and less troublesome compared to completing a traditional questionnaire.

### DRAWING FIGURES

FIG. 1 is a block diagram describing one embodiment in accordance with the present invention.

FIG. 2 is a flow diagram showing single-action survey of one embodiment in accordance with the present invention.

FIGS. 3 and 4 are illustrations of one embodiment in accordance with the present invention.

FIGS. 5 and 6 are flow diagrams depicting surveys having single-action features in accordance with the present invention.

FIGS. 7-A, 7-B, and 8 are illustrations of embodiments in accordance with the present invention.

FIG. 9 is a flow diagram showing single-action survey of one embodiment in accordance with the present invention.

FIGS. 10, 11, and 12 are illustrations of three embodiments in accordance with the present invention.

FIG. 13 is a flow diagram showing single-action survey of one embodiment in accordance with the present invention.

FIG. 14 uses an exemplary diagram to depict survey method and survey content in accordance with the present invention.

FIGS. 15, 16, and 17 show dual-function buttons in an email interface in accordance with the present invention.

FIGS. 18 and 19 show dual-function buttons in a short message interface in accordance with the present invention.

FIGS. 20 and 21 show dual-function buttons in a tweet interface in accordance with the present invention.

FIG. 22 shows a button with a changeable size in an email interface in accordance with the present invention.

FIG. 23 shows a button with a changeable size in a tweet interface when a finger approaches in accordance with the present invention.

REFERENCE NUMERALS IN DRAWINGS

| | | | |
|---|---|---|---|
| 10 | Client System | 12 | Survey Database |
| 14 | Communication | 16 | Processor |
| | Network | 20 | Log Database |
| 18 | Processing Module | 26 | Survey Subject |
| 22 | Computer Readable | 30 | Graphic Object |
| | Medium | 32 | Graphic Object |
| 24 | Message | 34 | Survey Icon |
| 28 | Graphic Object | 36 | Display Surface |
| 31 | Message | 40 | Comment Pad |
| 33 | Graphic Button | 44 | Button |
| 35 | Graphic Button | 48 | Display |
| 38 | Area | 52 | Keypad |
| 42 | Button | 56 | Graphic Object |
| 46 | Button | 60 | Graphic Object |
| 50 | Client System | 64 | Survey Window |
| 54 | Display Surface | 68 | Client System |
| 58 | Graphic Object | 72 | Display Surface |
| 62 | Survey Icon | 76 | Microphone |
| 66 | Client System | 80 | Client System |
| 70 | Survey Window | 84 | Hand |
| 74 | Speaker | 90-98 | Graphic Buttons |
| 78 | Client System | 202 | Email Interface |
| 82 | Server System | 206-212 | Graphic Buttons |
| 86 | Check Mark | 216 | Email Interface |
| 200 | Client System | 220-228 | Graphic Buttons |
| 204 | Display Surface | 232 | Email Interface |
| 214 | Client System | 236 | Graphic Button |
| 218 | Display Surface | 240 | Short Message |
| 230 | Client System | | Interface |
| 234 | Display Surface | 244 | Short Message |
| 238 | Client System | 248-254 | Graphic Buttons |
| 242 | Display Surface | 258 | Short Message |
| 246 | Short message | | Interface |
| 256 | Client System | 262 | Short Message |
| 260 | Display Surface | 266 | Graphic Button |
| 264 | Short Message | 270 | Tweet Interface |
| 268 | Client System | 274 | Tweet Message |
| 272 | Display Surface | 278-284 | Graphic Buttons |
| 276 | Tweet message | 287 | Graphic Button |
| 286 | Client System | 289 | Graphic Button |
| 288 | Tweet Interface | 291 | Finger |
| 290 | Display Surface | 294 | Tweet Message |
| 292 | Tweet Message | | |
| 296 | Graphic Button | | |

120, 122, 124, 100, 102, 104, 106, 107,
108, 110, 112, 114, 116, 117, 118, 128,
130, 132, 134, 136, 138, 140, 142, 144,
150, 152, 154, 156, 158, 160, 162, 164,
166, 168, 170, and 172 are exemplary steps.

### DETAILED DESCRIPTION

The following exemplary embodiments are provided for complete disclosure of the present invention and to fully inform the scope of the present invention to those skilled in the art, and the present invention is not limited to the schematic embodiments disclosed, but can be implemented in various types.

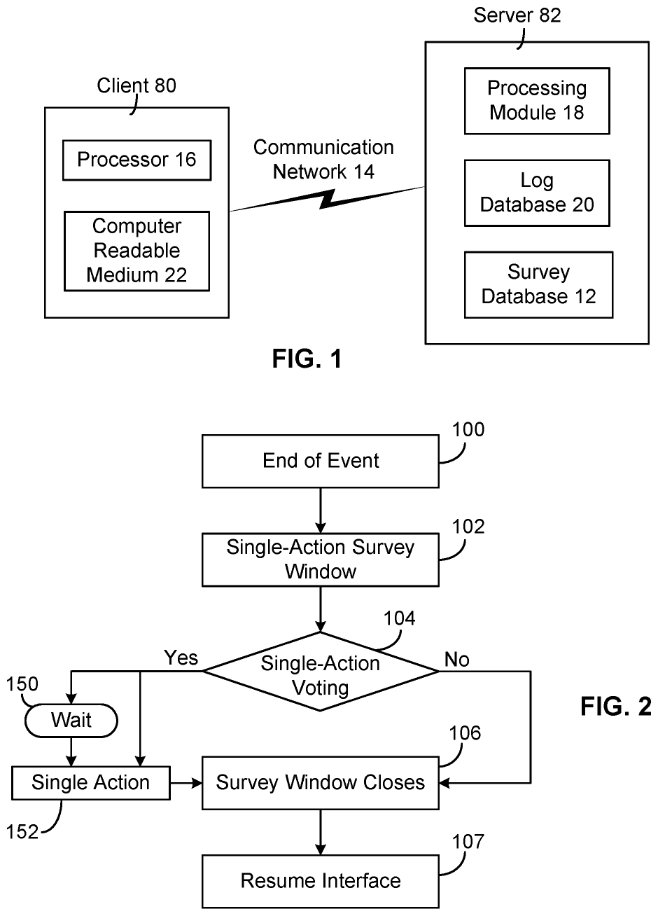

FIG. 1 is an exemplary block diagram of one embodiment according to the present invention. A client system 80 and server system 82 are connected via a communication network 14. Client 80 may represent an electronic device, including but not limited to a desktop computer, a tablet computer, a wireless gadget (such as mobile phone, smartphone, smart watch, and the like), etc. Client 80 may include a processor 16 and computer readable medium 22. Processor 16 may mean one or more processor chips or systems. Medium 22 may include a memory hierarchy built by one or more memory chips or storage modules like RAM, ROM, FLASH, magnetic, optical and/or thermal storage devices. Processor 16 may run programs or sets of executable instructions stored in medium 22 for performing various functions and tasks, e.g., playing video or music, sending messages, surfing on the Internet, electronic payment, surveys, games, etc. Client 80 may also include input, output, and communication components, which may be individual modules or integrated with processor 16. Usually, client 80 has a display with a graphical user interface (GUI). The display surface may also be sensitive to touches, especially in the case of tablet computer, smart phone, and smart watch. Client 80 may also have a voice recognition component to receive audio input from a user.

The word “server” means a system or systems which may have similar functions and capacities as one or more servers. Main components of a server may include one or more processors, which control and process data and information by executing software, logic, code, or carrying out any other suitable functions. A server, as a computing device, may include any hardware, firmware, software, or a combination. In the most compact form, a server may be built on a single processor chip. In the figure, server 82 may represent one or more server entities that collect, process, maintain, and/or manage survey information and documents, help conduct surveys, communicate with users, deliver information required by users, etc. Server 82 may exemplarily be divided into three blocks, represented by a processing module 18, a log database 20, and a survey database 12. Processing module 18 may include processing and communication functions. Log database 20 may store user ID information and survey ID information, which may be used to trace a survey result a user provided. Survey database 12 may store survey results and other survey related information, such as background information on survey events. Database 12 and 20 may include aforementioned memory chips and/or storage modules.

A communication network 14 may cover a range of entities such as the Internet or the World Wide Web, a local area network (LAN), a wide area network (WAN), a metropolitan area network (MAN), a telephone network, an intranet, wireless, and other types of networks. Client 80 and server 82 may be connected to network 14 by various wired, wireless, optical, or other connections.

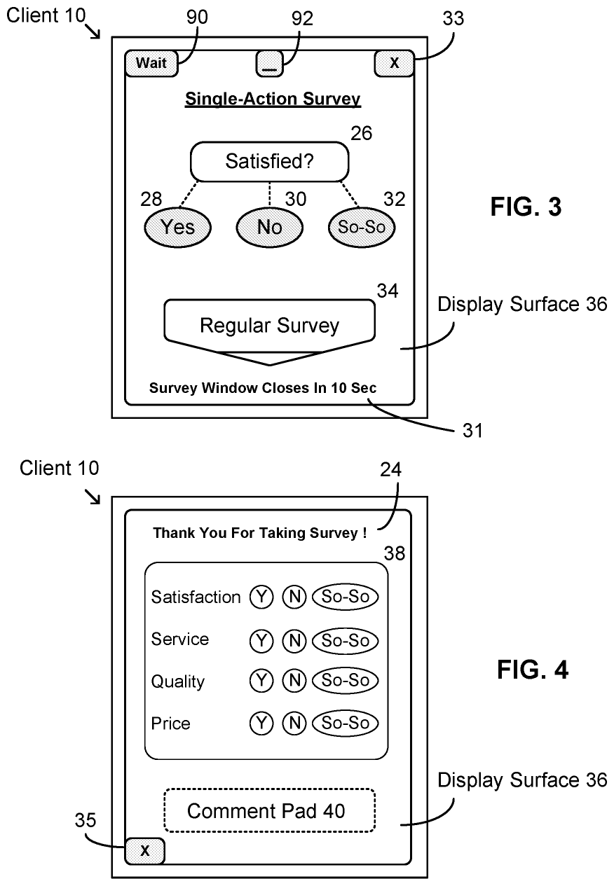

FIG. 2 is a schematic flow diagram showing one embodiment of single-action survey according to the present invention. Single-action survey may also be called one-action survey. FIG. 3 is an exemplary diagram of a client system 10 that may be used to illustrate the flow diagram of FIG. 2. Client 10 has a display surface 36, where messages and graphic objects or icons may be presented. Graphic objects may represent documents, applications, and functions, e.g., a textual file, photo album, browser, email, music, etc. Display surface 36 is also a GUI by which a user may interact with the client system and/or a remote server. Surface 36 may be a touch screen or touchscreen, which is sensitive to a touch or touches. A graphic object on the GUI of a touch screen may be selected or activated by a click using a mouse or more conveniently, by a touch or tap of a finger tip.

Returning to FIG. 2. Step 100 represents the end of a target event. The event may be a business-related transaction online or in a retail store, or a process related to other activities. Examples of events include online shopping, in-store shopping, dining, service, gaming, show, sport, community meeting, political gathering, and so on. Next at Step 102, a survey window shows up, which may be depicted exemplarily by FIG. 3. The view on surface 36 of FIG. 3 may be considered as a survey window, where a title says “Single-Action Survey” and a graphic object 26 indicates the survey subject is “Satisfied?”. In practice, the title may be rewritten as “Survey on Fast Burger” if assuming a user just made a purchase at an eatery Fast Burger. Below object 26, there are graphic objects 28, 30, and 32, corresponding to “Yes” (satisfied), “No” (not satisfied), and “So-So” (average), respectively. As used herein, graphic objects and buttons indicate interactive graphic elements presented on a display, and can be activated by clicking/tapping on them by a user. The three objects represent three answers for a single-action survey and are used to illustrate survey processes for various embodiments to be discussed. Besides the three-answer format, other forms may be arranged as well. For example to achieve enhanced precision, five answers may be used which may be very good, good, average, bad, and very bad. And there may be certain seven-answer configuration, too. However, an answer selection process would be more acceptable if it is simple, easy, and straightforward, which is also the essence of the single-action survey. At Step 104 “Single-Action Voting”, a user may choose to participate or not to participate in a survey. When participating in a survey, a user may start a survey right away at Step 152 or choose to wait for some time at Step 150. When doing Step 152, a user may select one from the three answers, i.e., voting among objects 28, 30, and 32. Selecting an object may be implemented by a click on it using a mouse or a direct touch or tap on it on surface 36 if the surface is touch sensitive. The single-action survey is designed such that selecting any one of objects 28, 30, and 32 results at Step 106, closure of the survey window and ending of the survey. If a user doesn't want to take the survey, he or she may select a “Close” button 33 on the GUI or surface 36 to reach Step 106. Alternatively, if a user doesn't select any object within a sufficiently short period of time, it may be deemed “not participating” and the survey window and survey session will be closed automatically. Finally, Step 107 may show an interface before the survey or other predetermined content on surface 36.

The above described survey requires only one action, i.e., a click, a touch, or other single actions as illustrated above and below, or no action. The whole survey process is simple, swift, easy, and less intrusive, and thus more likely to be accepted by users than a traditional survey. For example, when a user purchases a cup of coffee at a coffee shop, a smartphone may be used to pay for it in an electronic payment process. The transaction may be concluded after the user waves the smartphone in front of a cash register. Then a survey window may appear on the smartphone's touch screen or GUI. The user may give a quick touch on the screen, maybe costing one or two seconds. After that, the survey ends, the survey window closes automatically, and the smartphone screen may return to its previous GUI.

Therefore compared to a traditional questionnaire-type survey, a single-action survey is more convenient, takes less time, and thus may be more acceptable by average people. Although single-action surveys have a simple output, for a shop manager, the survey results may still yield important information about product quality and customer service.

Back to FIG. 1, a single-action survey may be executed by processor 16. The launch of survey may be triggered by a monitoring program of the client system that receives the information of event completion, or by instructions sent by an organization which conducts or oversees the event, or a third party which is informed of the event status. The third party may be a local device or a remote system. It is noted that a client system may or may not be involved in a target event. For example, a smartphone may be used for electronic payment and then for a survey after the payment is made. On the other hand, when a credit card is used for payment, and a smartphone is registered with the credit card, the smartphone may receive instructions to start a survey too. Survey related information, including case ID, user ID, survey results, any user input, and event info, may be sent to server 82 by processor 16 via network 14. Server 82 may, for instance, store case ID, survey results, user input, and event info in survey database 12, and keep user ID and case ID in log database 20. Alternatively, survey related information may be transmitted to a local device which in turn may relay the information to a remote server. Additionally, processor 16 may send survey related information to a local device which may pass it to a local database. For instance, a shop owner may want to keep a copy of survey data collected from customers, and conduct own customer research and analysis.

The wait stage at Step 150 may be initiated by clicking or tapping a “Wait” button 90 on surface 36 and may last for some time which may be set up by a user. For instance, after a user makes a payment at a store, the user may have to wait for his order (such as waiting in line for a burger or drink), or may have hands full, thus the user may want to delay a survey until a shopping process is concluded or when it's more convenient to do so. There is also a “Shrink” button 92 located between buttons 90 and 33. Clicking or tapping button 92 causes shrinkage of survey window and suspension of survey process, which may turn the window into a small graphic icon or send the session to an alert list. The suspended process may be resumed when being activated through clicking or tapping the shrunk icon or a corresponding item on the alert list.

The single-action survey window of FIG. 3 may also contain other functions on the GUI. For example, there may be a message 31 assuring users the survey window will close by itself shortly, say in ten seconds. In order to reduce intrusiveness, the window should be closed automatically when a user is busy with other things or ignores the survey. The window should be closed quickly, such as within a period from a couple of seconds to a minute. Although most people would like to do single-action survey, there are some people who nonetheless want to spend time to provide more information regarding customer experience and feeling. Thus, the GUI or surface 36 may also include a “Regular Survey” object 34 to provide an opportunity for users to take a regular or traditional survey that has multiple questions. Once object 34 is selected, a window of a regular survey may show up on the GUI, signaling a new session.

FIG. 4 shows an exemplary embodiment of regular survey in accordance with the present invention. The GUI in FIG. 4 may be generated after a user chooses to take a regular survey by clicking or tapping graphic object or button 34 as shown in FIG. 3. Below a “Thank You” message 24, there is an area 38 containing multiple exemplary questions, such as opinions on satisfaction, service, quality, price, etc. More questions and/or more pages may be arranged for a regular survey. At the bottom of the GUI, a comment pad 40 may be provided for users to express more on their experience by writing essays or any comments. Once pad 40 is clicked, a workspace may be generated, where a user may leave comments, suggestions, or wishes. The workspace is not shown in FIG. 4 for brevity reasons.

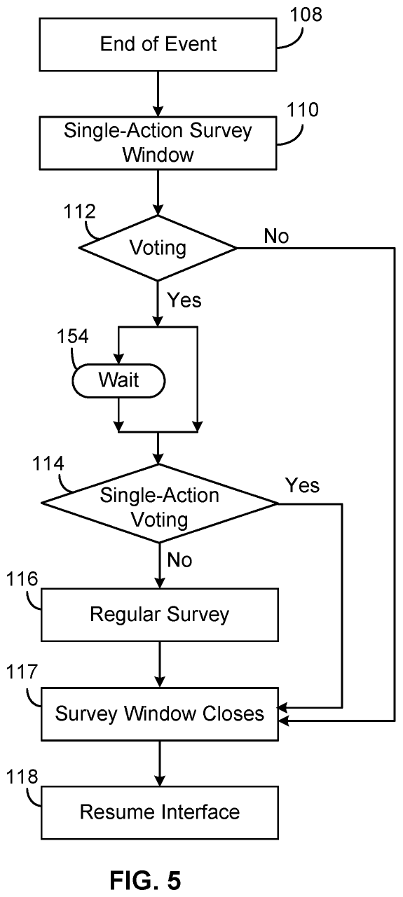

FIG. 5 is a schematic flow diagram of one embodiment having both single-action and regular survey options. It starts with Step 108, the end of an event. Next a single-action survey window shows up at Step 110. A user can choose whether or not to participate in a survey at Step 112. If the answer is no, the user may use a single click or single tap to close the survey window (e.g., selecting a “Close” button), or ignore the survey by doing nothing, which prompts Step 117, closure of the survey window. If the user wants to take the survey, he or she may either take Step 154 to wait for a certain period of time, or go to a survey session directly. In the latter case, he or she may make another decision at Step 114. If a single-action survey is preferred, one question is asked. Answering the single question leads to Step 117, closing the survey window. On the other hand, a user may also choose a regular survey and enter Step 116, where multiple questions are presented, as well as a platform for taking user comments, which is followed by window closing Step 117. Finally at Step 118, the GUI may resume its original state or start a new session. Back to Step 154, once a waiting period comes to an end, either automatically or initiated by a user, the user may start from Step 114 and proceed to reach Step 118 as discussed before. The length of the wait time may be selected or arranged by the user. A wait process may be interrupted by a user at any time. During the wait time, a survey window may stay or be closed temporarily, depending on the arrangements.

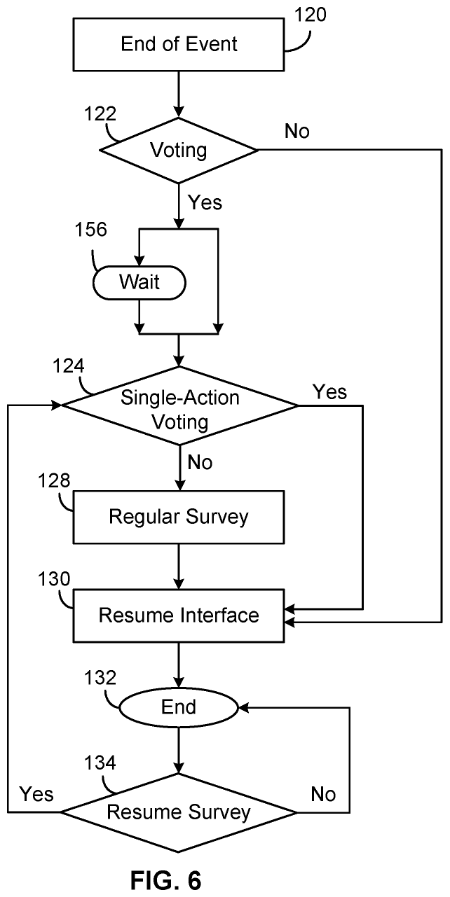

FIG. 6 shows a schematic flow diagram of another embodiment in accordance with the present invention. Like the flow diagram shown in FIG. 5, the process begins with the end of an event at Step 120. Next, a survey window (not shown) opens. If a user doesn't want to take part in the survey at Step 122, the window closes with a single action or no action, and the GUI returns to its previous setting at Step 130. If a user participates in the survey, two options are presented: To proceed with the flow or to wait for a while. In the former situation, a single-action voting may take place at Step 124, and the original GUI resumes at Step 130 after the survey window closes. Additionally, a user may choose to pass the single-action voting, and go to a regular survey session at Step 128, where the user may answer questions and/or post comments. After that, the GUI resumes at Step 130. When a user chooses to wait at Step 156, the survey process is postponed. The delayed process may resume automatically or get restarted by a user's instruction. Once a survey session returns, it may begin from Step 124 and continue as the diagram describes.

Returning to the previous interface or GUI before a survey session may also mean Step 132, the end of a survey. However every now and then in real life, users may want to take part in a skipped survey, adjust their submitted survey answers, add a comment, or rewrite a posted essay. To satisfy such demands, a client system may provide an option or application which allows a user to redo a survey or take a survey session which was missed in the past. At Step 134, a user may decide whether or not to go back to a survey. Going back means returning to Step 124 with a GUI displaying a single-action survey window, where there are options for the single-action and regular surveys. Referring to FIG. 1, in order to resume a survey, client 80 may send to server 82 a request, plus a customer's user ID and case ID. Server 82 may verify the ID information based on the data stored at log database 20, locate corresponding survey result at database 12 according to the ID info, and then send instructions and data to client 80. Once the user redoes the survey, results are transmitted to server 82. Then database 20 and 12 are updated using the new results. It may be designed such that a user may change survey results multiple times within a certain time frame.

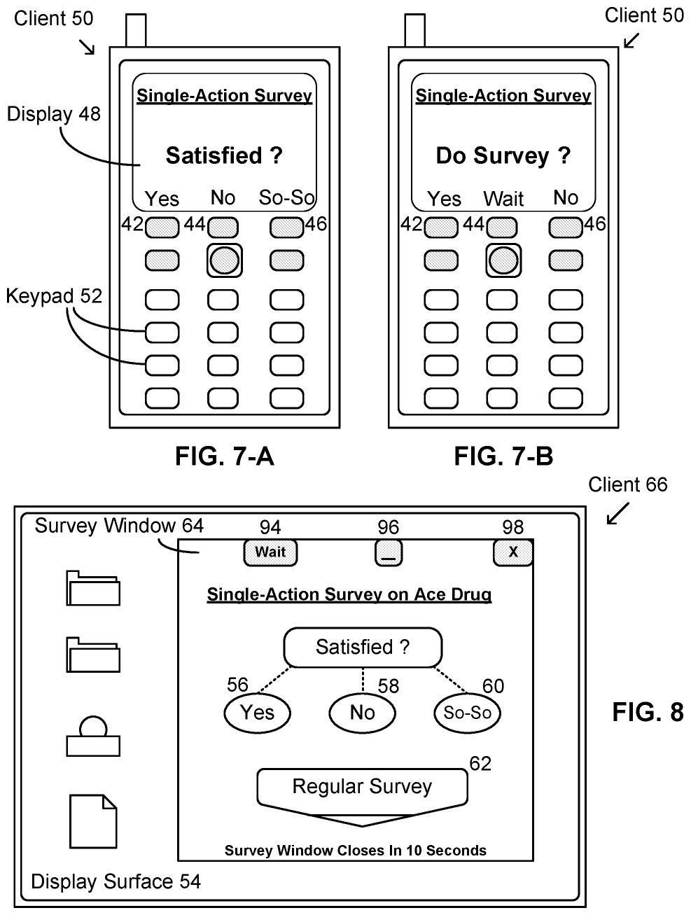

FIGS. 7-A and 7-B show exemplarily two diagrams of one embodiment. In FIG. 7-A, a client system 50 may be a mobile phone equipped with a keypad 52 and a display 48. Display 48 may not have a touch-sensitive screen, i.e., the display is for showing information and graphical objects only. In the figure, display 48 features a title “Single-Action Survey” and a survey subject “Satisfied?” at the end of an event. In real applications, the title may show store or event name to identify a survey target. In this design, the three answers “Yes”, “No”, and “So-So” cannot be selected either by touching or clicking. Instead, a survey answer may be chosen by pushing buttons 42, 44, or 46 individually. Again, after a single-action selection, display 48 returns to a previous setting. Therefore, it is still a single-action survey. The survey program may be embedded in a processor system of client 50; alternatively, it may also be installed as a specific application which may be downloaded from the Internet. Once a survey is concluded, survey related information may be transmitted by the client processor to a local device, which then forwards it to a local or remote survey database, or to a remote database directly via communication networks.

FIG. 7-B depicts schematically another scenario of the embodiment. If no action is received within a given period of time after the survey window shows up, the survey question may be changed to “Do Survey?”. Buttons 42, 44, and 46 now represent Yes, Wait, and No, respectively. Answer “Yes” implies a user would like to do the survey, and then the original survey window may return; “No” means a user doesn't want to do it, and thus the window resume a previous setting; and “Wait” means a user needs more time before starting a survey. If a certain period of time elapses without receiving any action from a user, the survey process may end automatically and the GUI in FIG. 7-B may go back to a previous configuration.

FIG. 8 is a graphic illustration of yet another embodiment in accordance with the present invention. A client system 66 may represent a smartphone, tablet computer, laptop computer, or desktop computer. A survey window 64 may show up after a purchase which is titled “Single-Action Survey on Ace Drug”. The window only takes part of a display surface 54 with file and program icons in the background. Surface 54 may be touch-sensitive. Graphic objects 56, 58, or 60, as the three answers of the single-action survey, may be selected by a mouse click, a finger tap, or another simple and easy action. Alternatively, a user may choose to take a regular survey by clicking or tapping object 62. The survey process and client device functions may be similar to those illustrated in the flow diagrams of FIGS. 5 and 6. In addition, a user may click or tap graphic button 94, 96, or 98 to keep window 64 staying longer for certain time, shrink the window, or close it respectively.

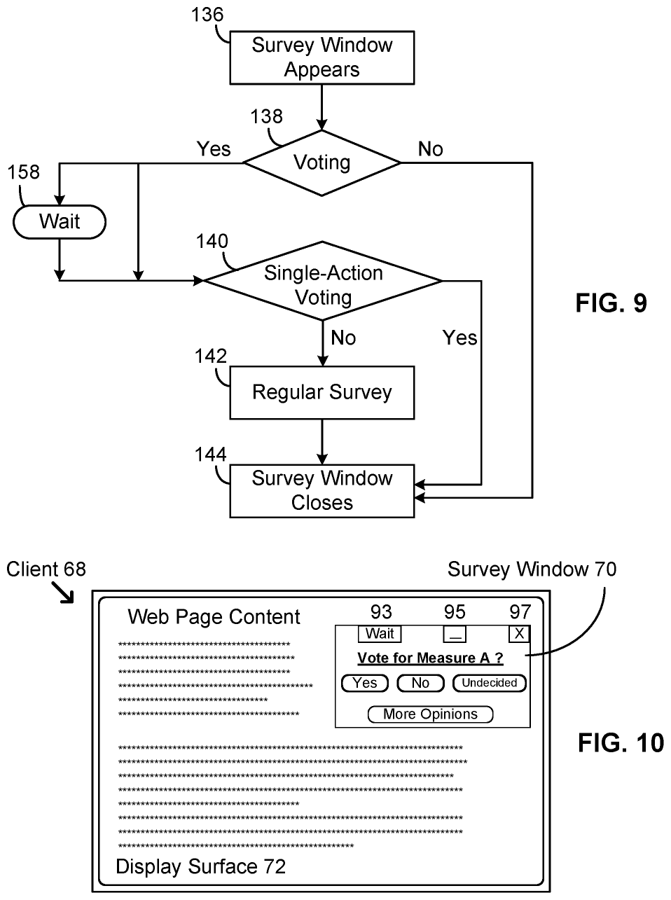

A survey implemented immediately after an event makes it natural and relevant. But some surveys are desirable before an event happens. Examples of this type include survey on social or political issues before an election, product surveys before release, surveys on future trends, and so on. Thus for certain subjects, a survey request may be presented to users before an event takes place. A surveyee may be randomly chosen in some cases, when there is no exact information about who is more relevant to an event. Starting time of some surveys may also be randomly arranged within a time frame. In such cases, the first survey step may be to create a survey window or start it audibly when there is no display in a client system. FIG. 9 illustrates schematically a flow diagram of one embodiment for such circumstances. Steps 136, 138, 158, 140, 142, and 144 exemplarily depict a survey process involving a single-action survey and regular survey, which may be similar to that shown in FIG. 5 except the start part. Thus the client processor system and other components here may have similar configurations and functions to the aforementioned for other embodiments illustrated. At Step 136, a survey gets started with displaying a survey window. A user may decide to do it or not at Step 138. If the invitation is rejected, the survey window closes at Step 144. If the user agrees to participate in it, he or she may want to wait for some time at Step 158, or go directly to Step 140, where the next decision is whether to do a single-action survey. When a single-action method is selected, the survey window closes at Step 144. Otherwise, a regular survey begins at Step 142 before the end of the process.

FIG. 10 shows an illustration of one embodiment of single-action survey regarding the scenario of FIG. 9. A browser component of a client system 68 may display online content items on a GUI or display surface 72. As pre-scheduled, a single-action survey window 70 appears. The popped up window may be arranged so that its appearance doesn't affect the view of online content items if possible. The survey window may temporarily take an empty space or ad space on surface 72. After a single-action selection is taken, the survey window may close, and previous content items or new content items may show up. As in aforementioned cases, wait, shrink, and close functions may be arranged using buttons 93, 95, and 97. If no action is detected in a given period of time, which may be sufficiently short, survey window 70 may close by itself. Client 68 may be a smart phone, a tablet computer, a desk-top computer, or other electronic gadgets or computing devices. The embodiments shown in FIGS. 9 and 10 may be useful for collecting opinions on a popular event or phenomenon, certain governmental policy, or any other issues involving the general public or a community.

For instance as shown in window 70, a survey question may be “Vote for Measure A?” and yes, no and undecided may be three answers represented by three interactive buttons for a single-action or one-action survey. In addition, another option is provided by button “More Opinions”. After a user taps “More Opinions”, another window may show up with more answers about the “Measure A” topic for a user to select, such as “Strongly Oppose”, “Strongly Agree”, and “Don't Care”. Alternatively, a “More Polling Questions” button may be configured, which leads to a new window with polling questions on other issues, such as “Mr. Smith for Mayor?”, “Vote for Sales Tax Increase?”, “New Cross-Bay Bridge?” and so on. Moreover, “More Opinions” and “More Polling Questions” buttons may be presented together in window 70, which gives a user three survey choices at the same time. Like foregoing survey configurations, a user input space may be arranged for a user to write comments or express opinions in a survey window.

Survey window 70 of FIG. 10 may also be used after an online event ends. For instance, after a user pays certain fees at a website of a government agency, checks account status at a bank website, or purchases a product at a shopping website, a survey window like window 70 may show up. A single survey question may be like “Satisfied?”, “Satisfied with Online Banking Service?”, “Satisfied with Shopping Experience?”, etc. Three answer buttons may be yes, no, and so-so. A “Regular Survey” button may be configured in the survey window too. Assume that a website showing the survey window is hosted by a web-hosting server. A server at a survey facility may send a signal to the web-hosting server after receiving a notice from latter. The signal may cause the web-hosting server to create a survey window at a user device. Then the server at the survey facility may conduct a survey process via the web-hosting server. A prearranged module at a web-hosting server may also be assigned to pop up a survey window after certain event ends and implement a survey session. The module may monitor whether a button or icon is activated in the window. A user may take a one-action survey and tap or click an answer button. To simplify a survey process further, it may be designed that activation of an answer button not only ends a survey, but also closes the survey window automatically. Hence, one action may be configured to perform two tasks. After a user taps an answer button, a thank-you message may be displayed briefly, say one or two seconds, in the survey window before the window is closed. The message may be used to assure a user that a survey is conducted besides expressing appreciation. If a regular survey is preferred, a user may tap or click the “Regular Survey” button. Then, a new window may appear to introduce more questions.

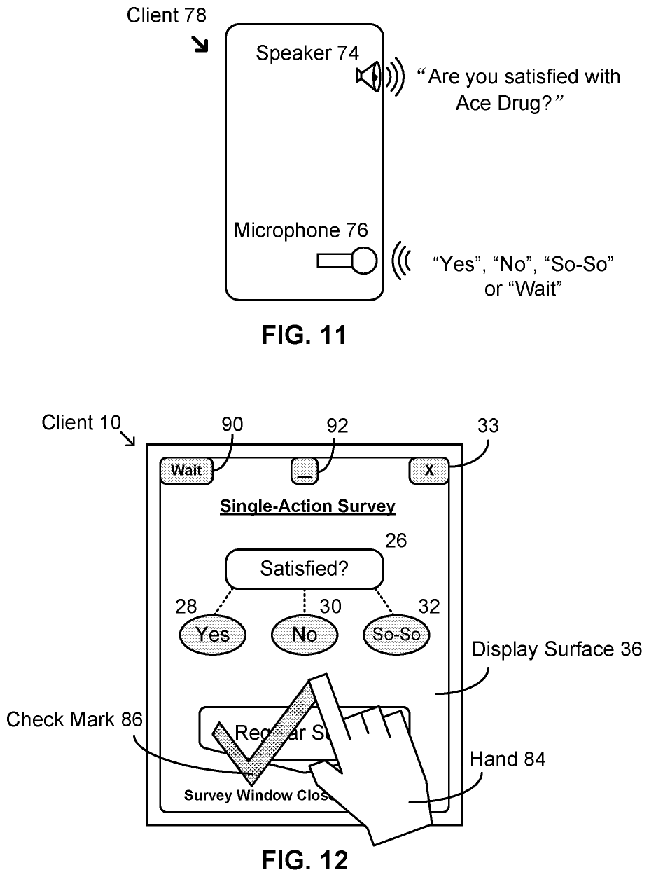

FIG. 11 illustrates an exemplary diagram of yet another embodiment in accordance with the present invention. A client system 78 may include a speaker component 74 and a microphone component 76. Speaker 74 may start a survey by producing an audible question regarding an event, like “Are you satisfied with Ace Drug?” after a transaction is completed. A user may speak to microphone 76, for instance, “Yes”, “No”, or “So-So”, as an answer. Depending on the system configuration, other words may also be used as a survey answer, such as “Excellent”, “Good”, “Very good”, “Not bad”, “Bad”, and so on. The one-word or short-sentence speech may be considered as a single-action reply, which causes ending of the survey. The user may also say “Wait” to get extra time before releasing a survey answer. As in other embodiments, a survey may end if no eligible audible reply is detected. At the end of a survey, client 78 may resume its previous operation status or return to a predetermined setting. Moreover, client 78 may be configured such that if a user answers “Regular survey”, a survey with multiple questions may begin. Thus it is yet another embodiment of single-action survey which has an option to do regular survey. However, unlike aforementioned cases, client 78 may not need a display, because a survey may be carried out audibly through exchange of sound and voice. Client 78 may be an electronic device which has a processor system, machine readable memory medium, stored executable instructions (e.g., programs and applications) like client 80 of FIG. 1. Because a display is not involved, Client 78 may eliminate a bulky display component as well as graphic processing related software and hardware. Client 78 may even eliminate mobile phone components, if wireless vocal communication is not in need. The client system may have functions which include starting a survey at the end of a target event or after receiving an instruction, concluding a survey when receiving a single-action or getting no action, and resuming the client's previous operation setting after a survey. Like client 80, the client system may carry out wired and/or wireless data communication with a local or remote device, and may also do other tasks like electronic payment transactions which may be desirable by shoppers, besides its speech recognition and voice generation capability. Client 78 may be supported by embedded programs and/or installed applications. Since there is no display, client 78 may be made substantially small in size and economic in cost for various mobile and/or disposable uses. For example, the processor system and other components of client 78 may be integrated into a few chips or even one chip, potentially suitable for mass production using semiconductor fabrication technologies.

FIG. 12 is an illustration of one embodiment which provides flexibility and additional convenience for a single-action response in a survey. Back to FIG. 3, a single-action voting may be performed by tapping button 28, 30 or 32 with a finger when display surface 36 is touch sensitive. In the process, a user has to make sure his or her finger tip aims at the right place or object, which may be burdensome when the user is on the run. As surface 36 is sensitive to touches, a contact detection module may be incorporated with client 10 that may detect not only a single touch or multiple touches, but also finger movement and trajectory on surface 36. As well known in the art, contact detection technologies may include capacitive, resistive, infrared, optical, surface acoustic wave, proximity sensing methods, etc. A proximity sensor array may also be employed to detect gestures of a finger or fingers above a screen surface. Returning to FIG. 12, the embodiment is still illustrated by client 10 with the same configuration as in FIG. 3. Assume client 10 is now equipped with contact sensing technologies and is able to detect finger touch, finger gesture, trajectory, or finger motion on surface 36. For example, when a check mark 86 is created by a hand 84 on the screen, client 10 may sense that a check-mark shaped object is drawn through suitable algorithms. Thus a user may set up a program or install an application which may recognize certain finger movements or gestures and take them as yes, no, or so-so respectively. For instance, a scribble making a check mark on surface 36 may be designated as yes (as shown in FIG. 12), a cross as no, a straight stroke as so-so, and a circle as wait (the latter three are not shown). Thus a user may finish a survey session by a quick scribble on the screen, which may be done easily and fast without paying much attention to the location his or her finger lands on over there. Therefore a single-action survey may become more convenient and more likely to be accepted.

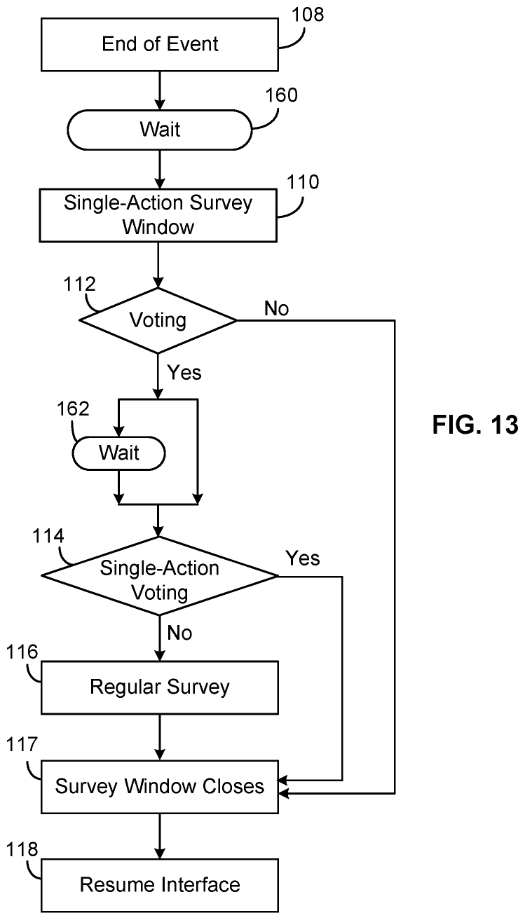

FIG. 13 shows a schematic flow diagram which is a modification of the embodiment depicted in FIG. 5. The main change is reflected by an added Step 160, a wait process, which may be used to delay Step 110, starting a single-action survey. The wait is desirable for certain applications. For instance, after an event ends, some users may not be ready to go through a survey. When in a shopping mall, a user may be busy with his or her shopping agenda or have hands full; or when purchasing a product at a store, a user may make a payment without taking out a smartphone. In the latter case, as the phone may be inside a pocket or bag, it is inconvenient and impractical to begin a survey which may rely on a phone screen. Thus, a survey session better be arranged to show up at a later time. The delay length may be determined by users on a category by category basis. To illustrate this change, Step 160 is inserted between Step 108 and 110, as depicted graphically in FIG. 13. Step 160 means there is a time delay before Step 110 takes place, or a survey window may occur at a predetermined time after an event is completed. This delay function may be applied to other embodiments illustrated above. Once Step 110 gets started, the process may run through Step 112, 117, 118, and maybe through Step 162, 114, or 116 as well, which is the same as the process illustrated in FIG. 5 and discussed accordingly.

Moreover, after an event, a single-action survey window may appear either on a device which a user uses or carries in the event, or on a device located at home or office. The place and timing of survey window appearance may be decided by a user in advance. For instance, a survey window may be arranged on a home computer or office computer, so that a user may complete it after things are settled down. Doing surveys at home may be especially preferred by users busy in day time, even though a survey requires only a single action.

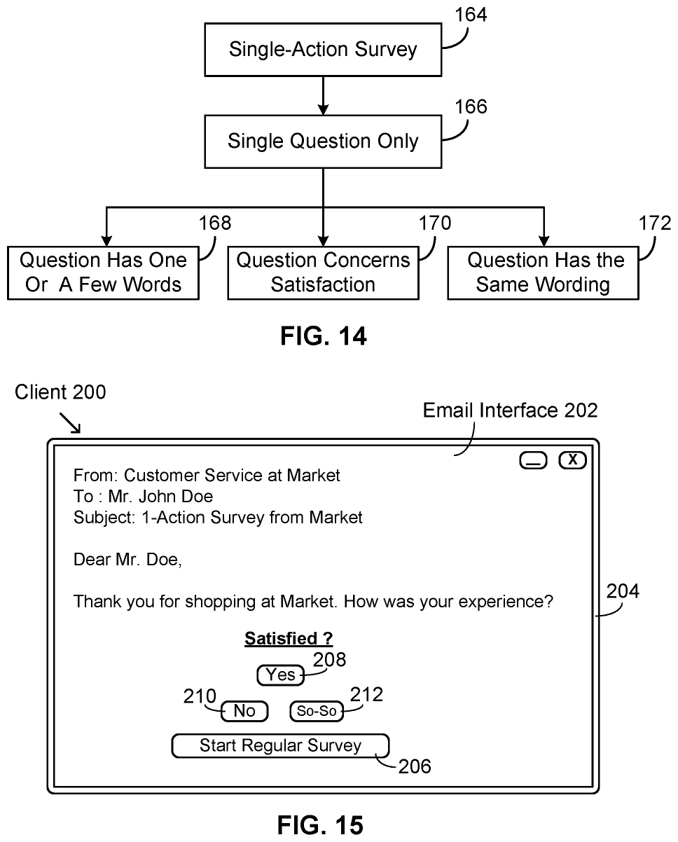

Referring to FIG. 14 which describes schematic methods to do a survey and exemplary survey content. Schemes to be described may apply to survey cases described above. As aforementioned, single-action surveys may be suitable for a wide range of activities, such as online shopping, in-store shopping, dining, service, gaming, entertainment, sports, community activity, political gathering, and so on. When a single-action survey is utilized for various events with far different features, not only survey procedures but also survey content is simplified. For instance as in the figure, when a single-action survey is conducted at Step 164, it may be designed that only a single question will be presented at Step 166. Thus for different events or even far different events, there may be only one question arranged in front of a user when a survey is carried out. It is noted that a single-question format doesn't exclude other options. Like shown in FIG. 3, a survey interface may display a single question plus other options such as button 34 which represents a chance to do a regular survey.

For a quick and easy survey, a single survey question should be simple, short, and easy to understand. Exemplary single question may include “Satisfied?”, “Are you satisfied?”, “Are you satisfied with Shop A?” or another short and easy-to-understand sentence. There are at least three types of single survey question, which may be applied to all foregoing and following cases.

At Step 168, a single survey question may be designed to have one or a few words only, like “Satisfied?” or other examples just mentioned. Thus a survey may be arranged to have a single question and the single question may contain a few words or even one word only. For instance, a single question may have at most seven words. Such a survey question may be arranged and suitable for different or even far different events, such as dining, shopping, auto repair, and ball games.

At Step 170, a single survey question may be designed to be related to user satisfaction, like “Satisfied?” and “Are you satisfied?” which are suitable for different or even far different events as well. So, when multiple surveys are conducted, the single question for each survey may focus on the same subject that is whether a user feels satisfied, regardless of how different the events are. In a sense, for this type of single question, question wording may change from one event to another; but its objective remains the same, i.e., to find out whether a user is satisfied regarding an event or experience. In other words, a single question may be always related to user satisfaction for a wide range of events.

Step 172 introduces the third type of single question. As a single question may be so simple and short while appropriate for different events, it may naturally address a general or universal issue. Thus, a single question may be created such that it may use the same wording repeatedly in many occasions for various events. It's obvious that an exemplary question like “Satisfied?” or “Are you satisfied?” fits the feature of this type. Such questions may be used repeatedly with the same wording for many events and many occasions, or the same wording of survey question may be used in surveys arranged for different or even far different events. Since sometimes survey questions may be written as “Satisfied with Shop A?” and “Satisfied with Shop B?”, the third type of survey question may be modified as a question with the same wording except the name of a survey target. Again, the modified survey question may be suitable and arranged for different or even far different events.

FIG. 15 shows an exemplary survey email with dual-function buttons in accordance with the present invention. The term email is also known as e-mail, electronic mail, or email message. A client system 200 shows an email interface 202 on a display surface 204 schematically. The client system 200 may represent a program or app (e.g., a survey program or a survey app). An email message page is presented in the interface 202. Assume that the email is constructed by an exemplary company called Market and the recipient is of Mr. John Doe. The email may be created and sent to Mr. Doe after Market or a survey facility receives info that Mr. Doe made a transaction like a purchase at Market. The email may be like a regular email and contains a survey presentation. As in FIG. 15, a simple question “Satisfied?”, an interactive button 206 for a regular survey, and three interactive answer buttons 208, 210, and 212 are configured in interface 202. A statement like “1-Action Survey” (Not shown) may also be displayed to let a user less concerned about survey length and effort. In addition, a “Close” button and “Shrink” button are arranged at the upper right corner. The “Close” button is presented in the interface such that a user may use it to close the email page. The “Shrink” button is presented such that a user may use it to shrink the email page to a small icon. After the client system 200 detects that the “Close” button is activated, the client system closes the current email page and display an inbox page.

Like aforementioned cases, a user is presented with two options, tapping an answer button to do a quick one-action survey or tapping button 206 to do a regular survey. Once an answer button, such as button 208, 210, or 212, is tapped or clicked, the one-action survey is concluded and a survey result is sent to a survey processing program at Market or the survey facility. Then, question “Satisfied?” may be replaced by a message such as “1-Action Survey Completed. Thank you!”, which may be presented on screen to make it clear that the quick survey is ended. While the conclusion announcement is displayed, button 206 may still remain there, continuing offering a chance for a regular survey. A user may close the message page or tap button 206 to answer more questions. Once button 206 is tapped or clicked, a new window may show up or a web page may appear as the start of a regular survey session.

A business or entity may collaborate with a survey facility and utilize an email service to design and construct a survey email. An email service is usually hosted by a server of an internet service provider. For instance, a business may obtain a survey module from the survey facility, create email content using an email service, and embed the module in the content. The module may be configured to present survey functions and content in an email. It may be arranged that either a survey facility or a business monitors and administers a survey process, like monitoring whether a button is activated and collecting and sorting survey data. After a user taps a button on a survey email page at a client system or user device, a signal may be sent from the device to the survey facility or a survey processing program at the business, depending on an arrangement.

Usually after a user reads an email message, the user may click a close button to leave a message page and return to an email inbox interface. Sometimes, a button with a backward symbol is used instead of the close button. An email inbox page or interface may display emails, e.g., a list of emails, including new and old ones. Since a user is supposedly going to leave a message page once a one-action survey is finished, it may be designed that activation of one of the answer buttons 208, 210, or 212 not only concludes a quick survey, but also closes the email page automatically. Thus, a user may enter an email inbox interface on a screen, tap or click a survey email to open a message page, take a brief look at the survey content, and then tap or click an answer button. Next, the client system receives a survey result that is submitted by the user and then sends out survey information to the survey facility or survey processing program. At the same time, the client system removes the message page from the screen, and displays the email inbox interface.

In current email configuration, tapping or clicking a close button represents the only method available to return to an email inbox interface from a message page. The close button is designed by an email service and arranged on a message page automatically. Although there is no need to create a redundant close button, it may be desirable to assign a page-closing function plus another function to an interactive button or icon to create a dual-function button. A dual-function button saves one step and thus may save time and improve user experience. To enable such a dual-function button, a service provider may configure an email system for an email service and make it available to add the page-closing function to a button which carries another function in the system. Thus when a business or entity constructs content items of an email, it may combine two functions to generate a dual-function button, where one function is of page closing. The button may have a shape such as a square, a rectangle, a circle, an oval, or an irregular shape.

In some embodiments, after a user taps a dual-function button, a thank-you message may be displayed briefly, say one or two seconds, on the message page before the page is replaced by an inbox page. The message may be used to assure a user that a survey is conducted besides expressing appreciation. In some other embodiments, after a user taps a dual-function button, the page is replaced by an inbox page without showing any message. Some user may appreciate a thank-you message, while some other users may prefer a simple and quick action without a thank-you message.

Assume that an email program is installed at a client system or user device for a user to access and manage emails. Alternatively, the user may also access and manage emails via a portal website of an email service. After the user launches the email program at the device or logs in an email account at the portal, an email interface may show up on a display screen. At the beginning, the email program or a server at the portal may present an inbox interface, where a list of interactive items representing new and old email messages may appear. The user may tap or click a list item to open a message and enter a message page. From another angle, after the program or the server receives info that a list item is activated, it may present content of a corresponding email on a message page and then keep monitoring whether a button is activated. Assume that an email contains a dual-function button. Then, the dual-function button and a regular close button may be displayed on the message page along with other interactive buttons and icons. When the program or server detects that the dual-function button is activated, it may perform the other function first before carrying out the page-closing function which shuts the message page. After the message page is closed, the inbox interface may be displayed. The page-closing function may also be implemented by replacing a message page by the inbox interface.

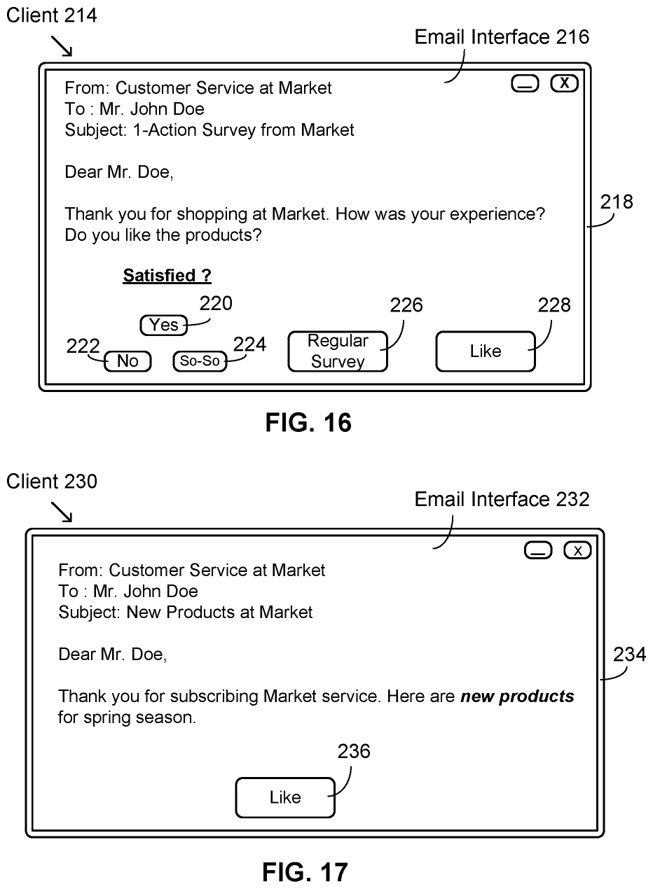

FIG. 16 shows another exemplary survey email with dual-function buttons in accordance with the present invention. A client system 214 shows an email interface 216 on a display surface 218 schematically. The client system 214 may represent a program or app (e.g., a survey program or a survey app). The configuration of interface 216 is similar to that of interface 202 shown in FIG. 15, but interface 216 is configured with a “Like” button, which is also a dual-function button. As shown in FIG. 16, a simple question “Satisfied?”, three interactive answer buttons 220, 222, and 224, and an interactive button 226 for a regular survey are configured in the interface. In addition, an interactive “Like” button 228 is arranged in the interface. The “Like” button 228 corresponds to the question “Do you like the products?” in the email message. Additionally, a “Close” button and “Shrink” button are arranged at the upper right corner. The “Close” button is presented in the interface such that a user may use it to close the email page. The “Shrink” button is presented such that a user may use it to shrink the email page to a small icon. After the client system 214 detects that the “Close” button is activated, the client system closes the current email page and displays the inbox page.

Like above-described cases, a user is presented with two survey options, tapping an answer button to do a quick one-action survey or tapping button 226 to do a regular survey. Further, the user is presented with another option to express or submit an opinion using button 228. If a user taps button 228, it may be considered that the user likes the products. As there are survey options and the “like” option, the dual-function buttons may be configured differently than what described above in FIG. 15. For example, it may be arranged that after the client system detects that an answer button, such as button 220, 222, or 224, is tapped or clicked, the client system may conclude the one-action survey and send a survey result to the survey processing program or survey facility. Then or at the same time, the client system may monitor whether button 228 is activated. After the client system detects that button 228 is activated by the user, which is after one of the answer buttons is tapped, the client system may send a message to report the event to the survey processing program or survey facility. Then or at the same time, the client system may close the email page and display the inbox page.

Hence, the client system 214 performs the dual functions after button 228 is activated and one of the answer buttons is activated. In another scenario, if the client system detects that button 228 is activated first and one of the answer buttons is activated subsequently, the client system may conclude the survey and close the email page simultaneously. As such the dual functions of the answer buttons 220-224 and 228 are performed only after one of the answer buttons and button 228 are activated. If it is detected that only one of the answer buttons or only button 228 is activated, the dual functions are not carried out, that is, the email page may remain and may not be replaced by the inbox page automatically.

FIG. 17 shows an exemplary email with a dual-function button in accordance with the present invention. A client system 230 shows a short message interface 232 on a display surface 234 schematically. The client system 230 may represent a program or app working at the client system. The interface 232 schematically shows a part of email content and an interactive “Like” button 236. The email may introduce new products to a user, e.g., Mr. John Doe. For example, the user may click on “new products”, i.e., a link, in the message to open a page of product introduction. The “Like” button 236 corresponds to an opinion of the user toward the email and/or the new products. In addition, a “Close” button and “Shrink” button are arranged at the upper right corner. The “Close” button is presented in the interface such that a user may use it to close the short message page. The “Shrink” button is presented such that a user may use it to shrink the page to a small icon.

After the user taps button 236, it may indicate that the user has read the message and may have reviewed the new products. As such, it is time to return to the inbox page. Thus, button 236 may be configured to have dual functions. The client system may monitor whether button 236 is activated. If the client system 230 detects that button 236 is activated by the user, the client system may send a message to report the event to the survey processing program or a service facility. At the same time, the client system may close the email page and display the inbox page.

In some other embodiments, more than one dual-function button or icon may be configured in interface 232. For example, a “Not Like” button (not shown) may be arranged in interface 232 for a user to express or submit another opinion that is different than the like opinion. The “Not Like” button may be configured to perform dual functions, submission of an opinion and closing the email page. After it is detected that the “Not Like” button is activated, the client system 230 receives the submitted opinion, sends a message to the service facility, closes or removes the email page, and displays the inbox page.

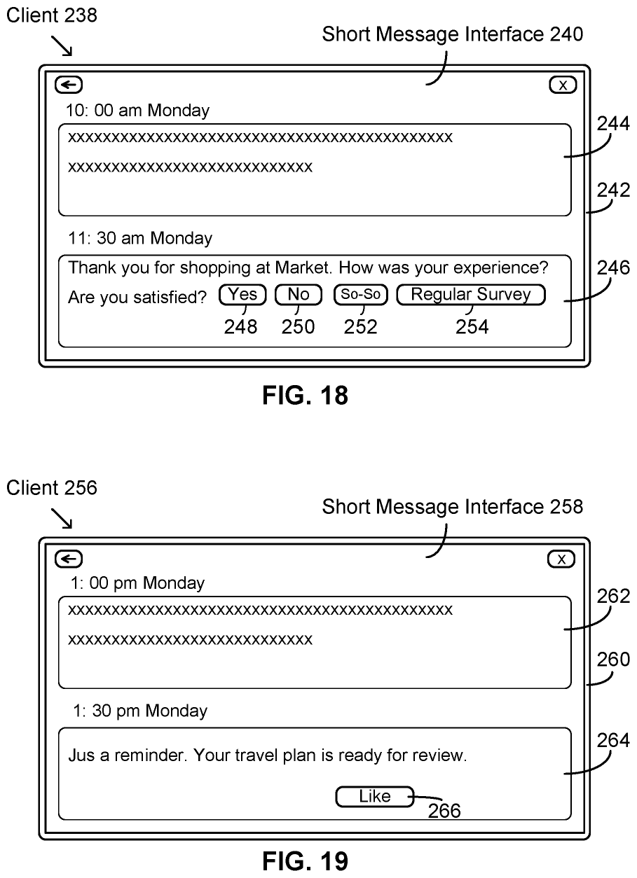

FIG. 18 shows an exemplary short message interface for a survey with dual-function buttons in accordance with the present invention. A client system 238 shows a short message interface 240 on a display surface 242 schematically. The client system 238 may represent a program or an app supporting short message functions. The configuration of interface 240 is similar to that of interface 202 shown in FIG. 15 in that both support the one-action survey and have similar survey buttons that perform dual functions, but interface 240 is configured for short messages, while interface 202 is for emails. As shown in FIG. 18, there are two exemplary messages 244 and 246. In message 246, there are a simple question “Are you satisfied?”, three interactive answer buttons 248, 250, and 252, and an interactive button 254 for a regular survey. As above described, the three answer buttons represent answers “Yes”, “No”, and “So-So”, respectively. Button 254 may lead to a page or a website where a regular survey may be conducted.

In addition, a “Back” button is configured at the upper left corner and a “Close” button is configured at the upper right corner. A user may use the “Back” or “Close” button to close the current short message page and return to the inbox page. In some embodiments, both the “Back” and “Close” buttons may be presented by the client system 238. In some other embodiments, one of the “Back” and “Close” buttons may be presented. After the client system 238 detects that the “Back” button or “Close” button is activated, the client system closes the current short message page and displays the inbox page.

Like above-described examples, a user is presented with two survey options, tapping an answer button to do a quick one-action survey or tapping button 254 to do a regular survey. Similar to the answer buttons shown in FIG. 15, answer buttons 248-252 have dual functions. Thus, it may be configured that after the client system detects that an answer button, such as button 248, 250, or 252, is tapped or clicked, the client system may conclude the one-action survey and send a survey result to the survey processing program or survey facility. Then or at the same time, the client system may close the short message page and display the inbox page. A short message inbox page or interface may display short messages, e.g., a list of short messages, including new and old ones.

FIG. 19 shows an exemplary short message interface with a dual-function “Like” button in accordance with the present invention. A client system 256 shows a short message interface 258 on a display surface 260 schematically. The client system 256 may represent a program or app working at the client system. There are two exemplary messages 262 and 264. In message 264, an interactive “Like” button 266 is configured for a user to express or submit a positive opinion in regard to the content of the short message. If the user taps button 266, it may indicate that the user has read the message and likes it. Then, it is time to return to the inbox page. The user may click a “Back” button at the upper left corner or click a “Close” button at the upper right corner to return to the inbox page. As such, in order to save a step, button 266 may be configured to have dual functions. The client system may monitor whether button 266 is activated. If the client system detects that button 266 is activated, the client system may send a message to report the event to the survey processing program or service facility. At the same time, the client system may close the short message page and replace it with the inbox page. Hence, button 266 is arranged to perform dual functions, expressing or submitting an opinion and returning to the inbox interface.

In some other embodiments, more than one dual-function button or icon may be configured in interface 258. For example, a “Need to Change” button (not shown) may be arranged in interface 258 for a user to express or submit a request or another opinion that is different than the like opinion. The “Need to Change” button may be configured to perform dual functions, submitting a request or opinion and closing the short message page. After it is detected that the “Need to Change” button is activated, the client system 256 receives the submission of the request or opinion, sends a message to the service facility, closes or removes the short message page, and displays the inbox page.

Besides emails and short messages, dual-function buttons may also be configured in tweets or tweet messages. A tweet may represent a social media posting or message at a social media platform.

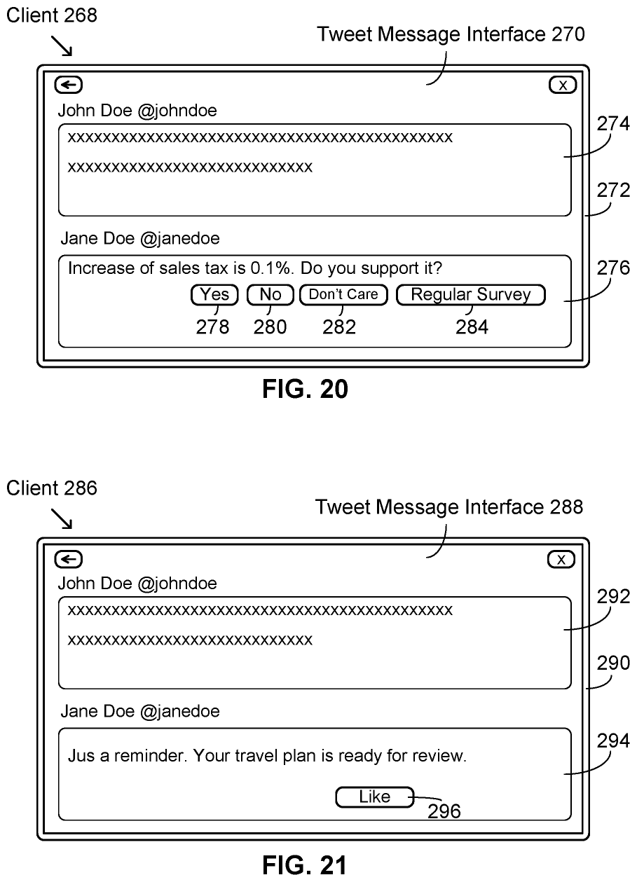

FIG. 20 shows an exemplary tweet message interface for a survey with dual-function buttons in accordance with the present invention. A client system 268 shows a tweet interface 270 on a display surface 272 schematically. The client system 268 may represent a program or an app supporting tweet functions. The configuration of interface 270 is similar to that of interface 240 shown in FIG. 18 in that both support the one-action survey and have similar survey buttons that implement dual functions, but interface 270 is configured for tweet messages, while interface 240 is for short messages. As shown in FIG. 20, there are two exemplary tweets 274 and 276. In tweet 276, there are a simple question “Do you support it?”, three interactive answer buttons 278, 280, and 282, and an interactive button 284 for a regular survey. The three answer buttons may represent answers “Yes”, “No”, and “Don't Care”, respectively. Button 284 may lead to a page or a website where a regular survey with more questions may be conducted.

In addition, a “Back” button is configured at the upper left corner and a “Close” button is configured at the upper right corner. A user may use the “Back” or “Close” button to close the current tweet page and return to the inbox page. In some embodiments, both the “Back” and “Close” buttons may be presented by the client system 268. In some other embodiments, one of the “Back” and “Close” buttons may be presented. After the client system 268 detects that the “Back” button or “Close” button is activated, the client system closes the current tweet page and displays the inbox page.

Like above-described examples, a user is presented with two survey options, tapping an answer button to do a quick one-action survey or tapping button 284 to do a regular survey. Similar to the answer buttons shown in FIGS. 15, 16, and 18, answer buttons 278-282 also may have dual functions. Thus, it may be configured that after the client system detects that an answer button, such as button 278, 280, or 282, is tapped or clicked, the client system may conclude the one-action survey and send a survey result to the survey processing program or survey facility. Then or at the same time, the client system may close the tweet message page and display the inbox page. The tweet inbox page or interface may display tweets, e.g., a list of tweets, including new and old ones.

FIG. 21 shows an exemplary tweet message interface with a dual-function “Like” button in accordance with the present invention. A client system 286 shows a short message interface 288 on a display surface 290 schematically. The client system 286 may represent a program or app working at the client system. There are two exemplary tweet messages 292 and 294. In message 294, an interactive “Like” button 296 is configured for a user to express or submit a positive opinion in regard to the content of the tweet. After the user taps button 296, it may indicate that the user has read the message and likes it. Then, it is time to return to the inbox page. The user may click a “Back” button at the upper left corner or click a “Close” button at the upper right corner to return to the inbox page. Alternatively, in order to save a step, button 296 may be configured to have dual functions. The client system may monitor whether button 296 is activated. If the client system detects that button 296 is activated, the client system may send a message to report the event to the survey processing program or service facility. At the same time, the client system may close the tweet message page and replace it with the inbox page. Hence, button 296 is arranged to perform dual functions, expressing or submitting an opinion and returning to the inbox interface.

In some other embodiments, more than one dual-function buttons or icons may be configured in interface 288. For example, a “Need to Upgrade” button (not shown) may be arranged in interface 288 for a user to express or submit a request or another opinion that is different than the like opinion. The “Need to Upgrade” button may be configured beside button 296 and perform dual functions, submission of a request or opinion and closing the tweet page. After it is detected that the “Need to Upgrade” button is activated, the client system 286 receives the submission of the request or opinion, sends a message to a service facility, closes or removes the tweet page, and displays the inbox page.

In embodiments as shown in FIGS. 15-21, two options are provided for a user to close a message page, such as an email page, a short message page, or a tweet page. For example, a user may click the “Close” button or “Back” button to close the message page, which is the first option. The user may also click a dual-function button, such as one of the survey answer buttons or the “Like” button to perform a task and close the message page simultaneously, which is the second option. The task may include submitting a survey answer, e.g., “Yes”, “No”, or “So-So” for a one-action survey, submitting an opinion such as like, or another suitable action.

For example, a client system may present an email on an email page, a short message on a short message page, or a tweet message on a tweet page. If the client system detects that the “Close” button or “Back” button is activated, the client system may close the message page and displays the inbox page. If the client system detects that one of the answer buttons for a one-action survey is activated, the client system may conclude the survey, send a survey result to the survey facility, close the page, and display the inbox page. If the client system detects that the “Like” button is activated, the client system may send a message to the service facility, close the message page, and display the inbox page. As such, the dual-function button saves one step for a user and thus saves time and may improve user experience.

When a survey is embedded in an email, a short message, or a tweet message, it may make more users to submit an answer, i.e., activating an answer button, if the answer button gets the users' attention. As a larger button may stand out among content items, and a larger button is easier to tap or click, a button with an enlarged size may attract more attention, make answering a question more convenient, and encourage more users to express themselves (e.g., participating in surveys). In descriptions below, a display screen may be touch sensitive or not touch sensitive. When the display screen is not touch sensitive, certain methods apply when it is suitable.

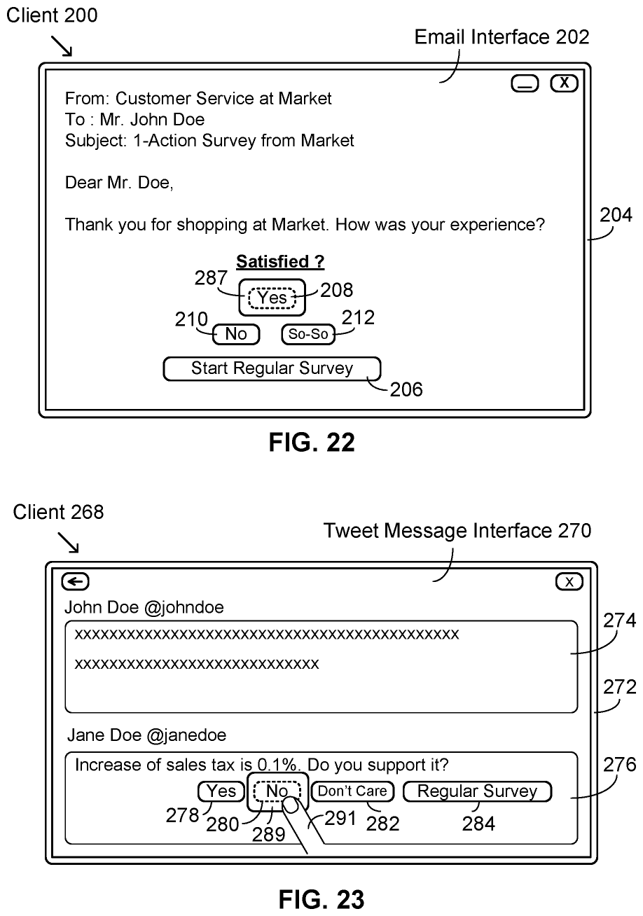

Referring to FIG. 15, in some embodiments, “Yes” button 208 may have a changeable size. For example, button 208 may have a larger size when the email message is displayed. As shown schematically in FIG. 22 that is based on FIG. 15, a button 287 is presented for a predetermined period of time (e.g., at least 2-10 seconds) after the email message page is displayed. Button 287 has a label “Yes” and a larger dimension than button 208 that is shown by the dotted line. Button 287 may remain in interface 202 for the predetermined period of time and be replaced by button 208 after the period of time elapses. That is, the “Yes” button is larger initially and then shrinks to a normal size after a certain time to attract the attention but avoid annoyance or offense. The term “normal size” as used herein indicates a size of a button before it is enlarged or after it shrinks from an enlarged size. As button 287 has a larger size, its existence may be more noticeable, and hopeful a user may see it and tap or click it at the current time or later on. The method applies when the display surface 204 is touch sensitive or not touch sensitive.

In some cases, multiple select buttons may be presented with an enlarged size for a predetermined time after an email message page is displayed. For example, buttons 208 and 210 shown in FIGS. 15 and 22, buttons 220, 222, and 228 shown in FIG. 16 may have a larger size temporarily. When a button is enlarged temporarily, the button's label (e.g., a word or sign) may be enlarged as well. Optionally, when a button is enlarged, the size of the button may get increased, while the label of the button may remain unchanged. In some other cases, when a button is enlarged, the button may remain the same size, while the size of its label may be enlarged. Besides email messages, buttons with a changeable size as illustrated above apply to short message pages and tweet message pages, too. As such, when a user opens a short message or tweet message, a client system may show a message page, present one or more select buttons with an enlarged size for a certain time, and present the one or more select buttons with a normal size afterward. The select button may represent a survey answer or opinion answer.

In some cases, a client system does not show buttons with a changeable size when a message page is presented. It may happen when other content of the message already takes the screen space. In these cases, when a user scrolls down the message page, buttons with a changeable size appear. Once these buttons show up on screen, their size may be enlarged temporarily. Thus, when select buttons appear either by presentation of a page or a scrolling down act, the select buttons may show up with an enlarged size temporarily.

In some embodiments, a button may be enlarged when it is detected that a finger (or an external object) is proximate to the button. As aforementioned, a proximity sensor array may be installed at a screen to detect gestures of a finger above the screen surface. Assume the screen is parallel to a horizontal plane. As used herein, being in proximity to a button indicates a finger hovers above the button vertically or is proximate (e.g., about 1-5 millimeters away from the button) to the button horizontally. The close position of a finger may indicate a user is likely to tap the button. Thus, the button may be enlarged to make it a little easier to do a tapping act, while further encouraging the user to tap it. Referring to FIG. 20, when client system 268 detects that a finger hovers above button 280, client system 268 may enlarge button 280. The enlarged button is represented by a button 289 as shown in FIG. 23 that is based on FIG. 20. In FIG. 23, a finger 291 hovers over buttons 280 and 289, and button 280 is depicted by a dotted line for comparison purpose. Similar to the scenarios described above, a button and its label may or may not get enlarged together. For example, when button 280 is enlarged, the label of button 280 may or may not be enlarged in some cases. Optionally, when button 280 is enlarged, it may mean only the label of button 280 is enlarged, especially when button 280 has an invisible contour. Thus, a label or content item(s) of a label may represent a button sometimes. An enlarged label, as used herein, may indicate an enlarged contour or area of the label, an enlarged size of a word of the label, and/or an enlarged sign of the label.

In some embodiments, only select buttons may be enlarged when a finger approaches them. For example, only certain answer buttons for a survey (e.g., buttons 278 and 280) may be enlarged when they are approached by a finger with respect to FIGS. 20 and 23, while other buttons such as buttons 282 and 284 may have fixed dimensions even when it is detected a finger hovers over them.

In some cases, three modes may be arranged. Options may be provided for a user to select (or enable) a mode or disable all three modes. The options are configured for better user experience, as users have difference preferences. The options may be arranged for access at a setup section of an app or the client system.

In the first mode, after it is detected that a finger approaches a button by hovering over or being in proximity to the button, the size of the button may be enlarged for a preset time period, e.g., at least 2-10 seconds. During the preset time period, the button is enlarged whether or not the finger remains there. The button returns to its normal size after the preset time period passes.

In the second mode, a button is enlarged and keeps the enlarged dimensions when it is detected that a finger hovers over or is in proximity of the button. For example, when it is detected a finger is proximate to a button for a time period, the button may be enlarged during the time period. The button returns to its normal size after it is detected that the finger is no longer there.

In the third mode, a button is enlarged and keeps the enlarged dimensions when it is detected that a finger hovers over or is in proximity of the button. For example, when it is detected a finger is proximate to a button for a time period, the button may be enlarged during the time period. After it is detected that the finger is no longer there, the button may keep the enlarged size for a certain period of time, e.g., at least 2-10 seconds. During the period of time, the button remains enlarged even though the finger is absent. After the period of time, the button returns to its normal size.

Optionally, certain embodiments as illustrated above may be combined when it is suitable to do so. For example, a select button may be enlarged when the content of a page is presented. The button may return to its normal size after a certain time. Thereafter, the button may be enlarged again when a finger approaches it, and keep the enlarged dimensions for a certain time. In some embodiments, when a button is enlarged temporarily, the enlarged button may partially cover or block another button or item that is close to it. The finger-triggered-enlargement methods as illustrated above and shown in FIG. 23 apply to a page of an email, a short message, and a tweet message. As used herein, a finger may indicate a fingertip tip. In some cases, a finger may be replaced by any detectable external object. For example, when it is detected an external object (such a knuckle or a pen) approaches a select button, the button may be enlarged in similar manners to those illustrated above.

When a display screen is not touch sensitive, the finger-triggered-enlargement methods may be replaced by cursor-triggered-enlargement methods. For example, when a client system detects that a cursor enters an area of a select button, such as the cursor overlapping the select button, the select button may be enlarged temporarily in manners similar to those illustrated above. Thus, methods of the finger-triggered-enlargement may be applied to cases of the cursor-triggered-enlargement. For example, after a cursor overlaps a select button, the button may be enlarged temporarily for a certain time in one mode. In another mode, the button may be enlarged temporarily and then return to its normal size after the cursor leaves the area of the button.

### CONCLUSION, RAMIFICATIONS, AND SCOPE

Thus it can be seen that systems and methods are introduced for dual-function buttons and buttons with a changeable size.

The dual-function buttons have the following features and advantages:
(1). To conclude a one-action survey in an email and return to the inbox page simultaneously;
(2). To conclude a one-action survey in a short message and return to the inbox page simultaneously;
(3). To conclude a one-action survey in a tweet and return to the inbox page simultaneously;
(4). To express or submit an opinion in an email and return to the inbox page simultaneously;
(5). To express or submit an opinion in a short message and return to the inbox page simultaneously;
(6). To express or submit an opinion in a tweet and return to the inbox page simultaneously; and
(7). Two survey options are provided for a user, a one-action survey and a regular survey, via an email, a short message, or a tweet message.

The buttons with a changeable size have the following features and advantages:
(1). The size of a button is increased temporarily when a page is presented;
(2). The size of a button is increased temporarily when a finger approaches it; and
(3). A button with a changeable size may attract a user's attention and facilitate implementation of a survey.

Although the description above contains many specificities, these should not be construed as limiting the scope of the invention but as merely providing illustrations of some of the presently preferred embodiments. Numerous modifications will be obvious to those skilled in the art.

### Ramifications:

Speech recognition and voice generation functions introduced in FIG. 11 may be incorporated with other embodiments involving finger moves to take advantage of both the audio style and touch screen methods. For example, a survey may start with a voice (like “Are you satisfied with Ace Drug?”) and end with a scribbled check mark on a screen, or start with a survey window on a screen and end with a vocal reply “Yes”, “No”, “So-So”, or “Wait”. A user may also switch between audio mode and screen mode depending on different occasions.

Referring to the embodiment shown in FIG. 12, more finger movements may be utilized to signal single-action answers. For example, tapping using one finger, two fingers, or three fingers may represent three answers yes, no, or so-so; or touching or tapping on upper, middle and lower section of the screen may reflect the three answers respectively. Besides maneuvers by fingers, as known in the art, movement of hand on a touch screen may also be sensed and thus may be utilized as a single-action response. For example, a single action may be a touch, tap, or slide by hand.

Furthermore, a motion sensing component such as accelerometer and/or gyroscope may be added to a client system which senses the motion of the client device. For example, shaking or waving a mobile phone in vertical direction, horizontal direction, or in circle may respectively represent the three answers of single-action survey.

For mobile phone users, the launch of a survey may feature flashes of light from an embedded light emitting module, so that a user may not need to look at the screen closely to know a survey has started after a target event is over. This feature, when combined with other easy steps, makes a survey even more convenient. Flashing lights may also be used to remind a user of that a survey is in a wait period.

The process described in the flow diagram of FIG. 13 is also applicable when a user makes a payment using a credit card at a store. Assume a cell phone or home computer is registered with the credit card. Then, a survey window may be configured to show up on the phone screen or computer monitor afterwards. When and where a survey window appears may be set up by a user.

In FIGS. 2, 5, 6, and 13, the first step may also represent the beginning of an occasion, particularly in cases where multiple surveys are arranged for a big event which may contain several sessions, like concert, ball game, cruise, etc. When a survey starts at an early stage, survey results may cover feedback up to that point, thus producing more details.

A display or display device may include those which are designed for head mount and have a very small screen or a virtual screen. These displays may be used in virtual reality (VR) systems and augmented reality (AR) systems. Since VR and AR systems don't have a touch screen and computer mouse, button activation may be performed via other mechanisms like a hand and finger gesture, an eye movement, or a verbal input.

Lastly, when a device is equipped with proximity sensor or three-dimensional (3-D) gesture sensor, it may detect finger or hand position at a short distance away from it. Thus the finger and hand gesture and movement in the air may be used to complete a single action survey, too. Examples may include a check mark, circle, and straight line for the three answers created by a finger or hand in the air, preferably close to a screen of the device.

Therefore the scope of the invention should be determined by the appended claims and their legal equivalents, rather than by the examples given.

1. A method performed at an electronic device having a display and stored executable instructions, comprising:
1) presenting content of a page in an interface of the display;
2) presenting a graphic object with a first size in the interface for a predetermined time period when the content of the page is presented, the graphic object being interactive and having the first size and a second size, the first size larger than the second size;
3) presenting the graphic object with the second size in the interface after the predetermined time period elapses; and
4) in response to activation of the graphic object by a user, implementing a predetermined task.

2. The method according to claim 1, further including presenting the graphic object with a third size in the interface in response to detection of an external object in proximity of the graphic object after the predetermined time period elapses, the third size larger than the second size.

3. The method according to claim 2 wherein the graphic object is presented with the third size in the interface for a predetermined time.

4. The method according to claim 2, further including presenting the graphic object with the second size in the interface in response to detection of the external object no longer in proximity of the graphic object.

5. The method according to claim 1 wherein the graphic object represents an answer for a survey or an opinion and the predetermined task includes receiving the answer or the opinion from the user.

6. The method according to claim 5 wherein the predetermined task further includes closing the page.

7. The method according to claim 1 wherein the content of a page includes an email, a short message, or a tweet message.

8. A method performed at an electronic device having a display and stored executable instructions, comprising:
1) presenting content of a page in an interface of the display;
2) presenting a graphic object with a first size in the interface when the content of the page is presented, the graphic object being interactive and having the first size and a second size, the first size smaller than the second size;
3) presenting the graphic object with the second size for a predetermined time period in response to detection of an external object in proximity of the graphic object;
4) presenting the graphic object with the first size after the predetermined time period elapses; and
5) in response to activation of the graphic object by a user, implementing a predetermined task.

9. The method according to claim 8, further including presenting the graphic object with the second size during a period of time when it is detected that the external object is in proximity of the graphic object.

10. The method according to claim 8, further including presenting the graphic object with the second size in the interface for a predetermined time after the content of the page appears in the interface.

11. The method according to claim 8 wherein the graphic object includes a word or sign.

12. The method according to claim 8 wherein the graphic object represents an answer for a survey or an opinion and the predetermined task includes receiving the answer or the opinion from the user.

13. The method according to claim 12 wherein the predetermined task further includes closing the page.

14. The method according to claim 8 wherein the content of the page includes an email, a short message, or a tweet message.

15. A method performed at an electronic device having a display and stored executable instructions, comprising:
1) presenting content of a page in an interface of the display;
2) presenting a graphic object with a first size in the interface when the content of the page is presented, the graphic object being interactive and having the first size and a second size, the first size smaller than the second size;
3) presenting the graphic object with the second size during a time period when it is detected that an external object is in proximity of the graphic object;
4) presenting the graphic object with the first size when it is detected that the external object is no longer in proximity of the graphic object after the time period; and
5) in response to activation of the graphic object by a user, implementing a predetermined task.

16. The method according to claim 15, further including presenting the graphic object with the second size in the interface for a predetermined time after the content of the page appears in the interface.

17. The method according to claim 15 wherein the graphic object includes a word or sign.

18. The method according to claim 15 wherein the graphic object represents an answer for a survey or an opinion and the predetermined task includes receiving the answer or the opinion from the user.

19. The method according to claim 18 wherein the predetermined task further includes closing the page.

20. The method according to claim 15 wherein the content of the page includes an email, a short message, or a tweet message.
